(19) United States
(12) Patent Application Publication
(10) Pub. No.: US 2026/0270367 A1
(43) Pub. Date: Sep. 10, 2026

(54) AUTOMATIC VIDEOCONFERENCE FRAMING USING MULTIPLE CAMERAS

(71) Applicant: Hewlett-Packard Development Company, L.P., Spring, TX (US)

(72) Inventors: Naveen Kumar Bangalore Ramaiah, Austin, TX (US); David Jurbergs, Austin, TX (US); Michal Vaughn, Austin, TX (US)

(21) Appl. No.: 19/167,136

(22) PCT Filed: Mar. 30, 2023
(86) PCT No.: PCT/US2023/065179

§ 371 Date: Sep. 19, 2025

(51) Int. Cl. H04N 7/15; G06V 20/40; G06V 40/16

(52) U.S. Cl. CPC H04N 7/15; G06V 20/48; G06V 40/161

(57) ABSTRACT

A method is described in which a first video stream of a scene is received (602) from a first camera (102) and a second video stream of the scene is received (604) from a second camera (104a, 104b). A participant of interest is identified (606) in the first video stream and mapped (608) from the first video stream to the second video stream. A first pose of the participant of interest relative to the first camera is determined (610), and a second pose of the participant of interest relative to the second camera is determined (612). The first video stream and the second video stream are ranked (614) based on comparing the first pose and the second pose. The processor automatically switches (616) between sending one of the first video stream or the second video stream to a display system based on the respective one of the first video stream or the second video stream having a higher ranking.

### BACKGROUND

Videoconferencing technology allows for participants to communicate with one another from remote locations. As an example, a videoconferencing system may include a camera that generates audio and video streams that convey the voice and appearance of one or more participants, with a speaker that outputs audio received from audio steams of remote participants and a display that outputs video received from video streams of remote participants.

Different types of cameras may be used for videoconferencing. Mechanical pan-tilt-zoom (“PTZ”) cameras have physical components that allow them to pan, tilt, and zoom. Alternatively, electronic PTZ cameras are static cameras that use image processing techniques to simulate the effect of a mechanical PTZ camera. For instance, electronic PTZ cameras may capture a wide-angle image and then digitally zoom in and crop the image to create the illusion of pan, tilt, and zoom movements. In both instances, the pan, tilt, and zoom controls of the cameras may be adjusted in real-time to achieve framing of the videoconference participants based on where they are seated and who is talking.

### BRIEF DESCRIPTION OF THE DRAWINGS

The following drawings are provided to help illustrate various features of example of the disclosure and are not intended to limit the scope of the disclosure or to exclude alternative implementations.

FIG. 1 is a block diagram of an example system illustrating two videoconference endpoints connected over a network.

FIG. 2 is a block diagram of example components that can implement a videoconference system.

FIG. 3 illustrates an example videoconference environment and a videoconference system that includes a static primary camera and two pan-tilt-zoom auxiliary cameras.

FIG. 4A shows example image frames of the same videoconference environment scene, which are captured from a static primary camera (left) and an auxiliary camera (right).

FIG. 4B illustrates a feature mapping between features extracted from a primary camera image frame and corresponding features extracted from an auxiliary camera image frame.

FIG. 5A illustrates an example scene of a videoconference environment captured by a static wide angle-view camera, in which the videoconference environment includes two pan-tilt-zoom auxiliary cameras.

FIG. 5B illustrates an image frame from the static wide angle-view camera depicting the scene in FIG. 5A, in which participant locations have been identified and demarcated as bounding box regions.

FIG. 5C illustrates framing of the participants in the videoconference environment using only the static wide angle-view camera.

FIG. 5D illustrates framing of the participants in the videoconference environment using optimal framing of the participants among the static wide angle-view camera and two pan-tilt-zoom auxiliary cameras.

FIG. 6 is a flowchart setting forth the steps of an example method for automatically selecting video streams captured from different cameras of a multiple-camera videoconferencing system based on the video stream that optimally frames a participant of interest.

FIG. 7 is a flowchart setting forth the steps of an example method for automatically switching between video streams captured by a primary camera and an auxiliary camera to optimally frame a videoconference participant of interest using real-time calibration between the primary and auxiliary cameras.

### DETAILED DESCRIPTION

As described above, videoconferencing technology enables users (i.e., video conference participants) to communicate with one another from remote locations. In a non-limiting example, a videoconferencing system may include multiple cameras, with each camera generating audio and video streams that convey the voice and appearance of the participants. As also described above, videoconferencing systems may utilize different types of cameras, including mechanical PTZ and electronic PTZ cameras. During a videoconference, the pan, tilt, and zoom controls of the cameras may be adjusted in real-time to achieve framing of the videoconference participants based on where they are seated and who is talking.

In some existing videoconferencing systems, participants carry out a series of operations to pan, tilt, and zoom the MPTZ camera to capture a better framing of a participant, such as the active speaker. Manually directing the camera with a remote control is challenging and inconvenient. For these reasons, many videoconferencing systems use a fixed, wide-angle view of the entire room. In these instances, participants on the far-end of the room will be small in the image frame and can be difficult to view on the video stream.

It is an advantage of the present disclosure to utilize multiple cameras (e.g., at least one primary camera and at least one auxiliary camera) in a videoconferencing system and to provide automatic switching between the video streams being captured by those cameras in real-time to optimally frame a participant of interest (e.g., an active speaker). A participant of interest may be identified in a primary camera video stream, which may be captured with a primary camera having a wide view angle. The location of the identified participant of interest can then be mapped to the auxiliary camera video streams using a calibration between the multiple cameras, which may be performed in real-time or be based on offline calibration data. In some examples, camera parameters (e.g., pan, tilt, and/or zoom factors) may be determined to frame the participant of interest using an auxiliary camera, and to select the video stream that best frames the participant (e.g., the video stream that best frames the participant of interest's face).

By using multiple cameras in a videoconferencing system as described, users are provided with flexibility in videoconference layout choices, which overcomes the limitations of single camera system, or of multiple camera systems that do not allow for real-time calibration between cameras, dynamic mapping between video streams, and/or automatic switching between video streams to optimally frame a participant of interest. In examples described in the present disclosure, optimal framing output allows for an improved hybrid working experience to users.

Accordingly, systems and methods are described for relating position within the scene from the video stream of one or more primary cameras to the scene of one or more auxiliary cameras, for example, by extracting features and mapping each captured scene to one another. Using this mapping, a participant of interest that is identified in the first video stream may be identified in the other video stream from auxiliary cameras. A first pose of the participant of interest relative to the primary cameras is determined, and a second pose of the participant of interest relative to the secondary cameras is determined. The first video stream and the second video stream are ranked based on comparing the first pose and the second pose. A processor may then automatically switch between sending one of the first video stream or the second video stream to a display system based on the respective one of the first video stream or the second video stream having a higher ranking.

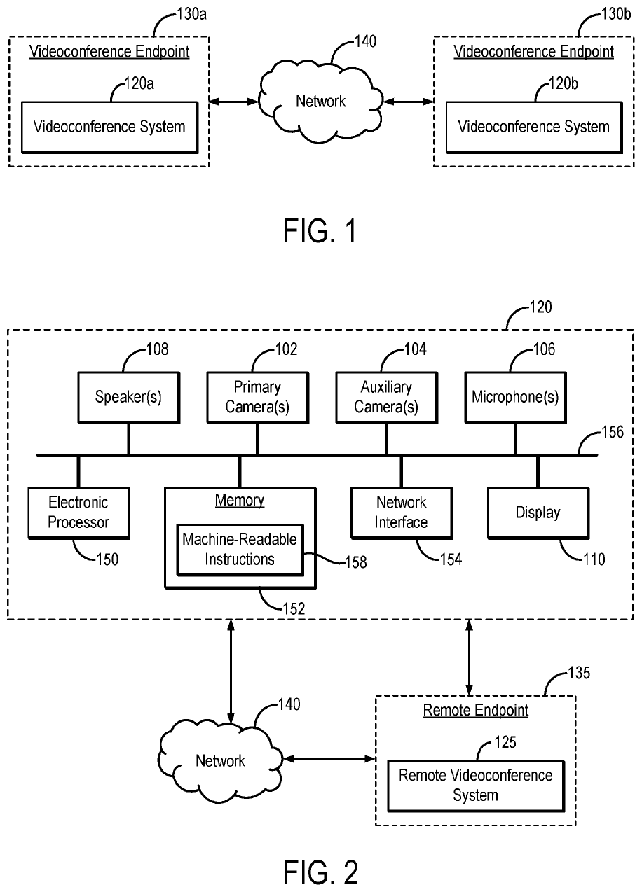

FIG. 1 illustrates an example system 100 for implementing communication between videoconference participants at one endpoint, such as a videoconference room, with remote participants at one or more remote endpoints. In the example illustrated in FIG. 1, the system 100 includes a first videoconference system 120a and a second videoconference system 120b (collectively referred to as “the videoconference systems 120” and generically referred to as “the videoconference system 120”) and a network 140. The first videoconference system 120a may include multiple cameras, with each camera generating audio and video streams that convey the voice and appearance of the participants at a first videoconference endpoint 130a. Similarly, in the illustrated example, the second video conference system 120b may include multiple cameras, with each camera generating audio and video streams that convey the voice and appearance of the participates at a second videoconference endpoint 130b. From the perspective of the first videoconference endpoint 130a, the second videoconference endpoint 130b is a remote endpoint, and similarly from the perspective of the second videoconference endpoint 130b the first videoconference endpoint 130a is a remote endpoint.

The system 100 can include additional, fewer, or different videoconference systems 120 than those illustrated in FIG. 1, and in various configurations. Each videoconference system 120 can be associated with a user, or with multiple users (e.g., multiple participants that are located at a single site). For example, the first videoconference system 120a can be associated with a first user, or first group of users, and the second videoconference system 120b can be associated with a second user, or second groups of users.

The first videoconference system 120a and the second videoconference system 120b can communicate over a network 140. The network 140 may be a long-range wireless network, such as the Internet, a local area network (“LAN”), a wide area network (“WAN”), or a combination thereof. In other examples, the network 140 may be a short-range wireless communication network, and in yet other examples, the network 140 may be a wired network using, for example, ethernet cables, USB cables, or the like. Additionally or alternatively, the network 140 may include a combination of long-range, short-range, and/or wired connections. In some examples, the network 140 may include both wired and wireless devices and connections. Additionally or alternatively, in some examples, two or more components of the system 100 can communicate through one or more intermediary devices not illustrated in FIG. 1.

Referring to FIG. 2, an example videoconferencing system 120 is illustrated. As described above, a videoconferencing system 120 may communicate with at least one remote endpoint 135 over a network 140, or via a direct communication link. As illustrated, the remote endpoint 135 may include a remote videoconferencing system 125, which in some examples may have components similarly arranged and configured as the videoconferencing system 120, or may have components in different arrangements, different configurations, or both.

The videoconferencing system 120 may include components for capturing audio and video streams, as well as presenting audio and video streams received from a remote endpoint 135. For instance, the videoconferencing system 120 may include at least one primary camera 102, at least one auxiliary camera 104, at least one microphone 106, at least one speaker 108, and at least one display 110. Additionally, the videoconferencing system 120 may include an electronic processor 150, a memory 152, and a network interface 154, which may all be coupled via and communicate over one or more control buses, data buses, etc., which can include a device communication bus 156. The control and/or data buses are shown generally in FIG. 2 for illustrative purposes. In some examples, one or more control and/or data buses can be used for the interconnection between and communication among the various modules, circuits, and components of the videoconference system 120

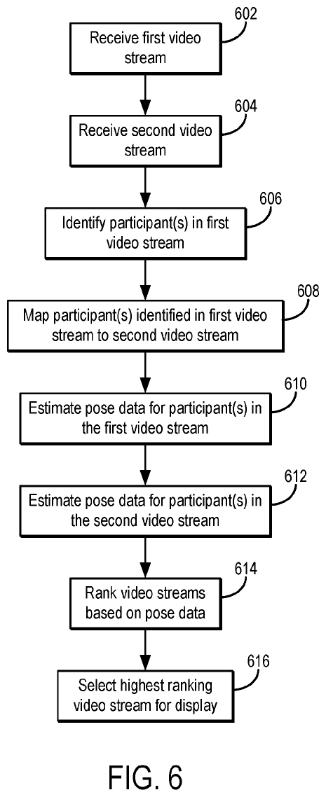

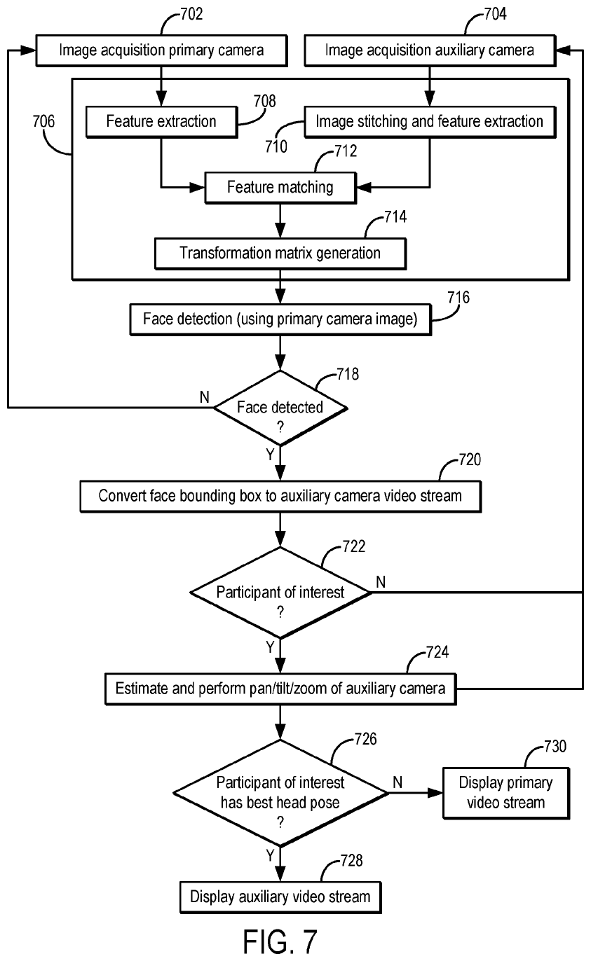

The electronic processor 150 communicates with the memory 152 to store data, to retrieve stored data, to processor data (e.g., audio stream data, video stream data), and the like. The electronic processor 150 may receive instructions 158 and data from the memory 152 and execute, among other things, the instructions 158. In particular, the electronic processor 150 may execute instructions 158 stored in the memory 152. Thus, the electronic processor 150 and the memory 152 may perform the methods described herein (e.g., aspects of the method illustrated in FIG. 6, aspects of the method illustrated in FIG. 7).

The memory 152 can include read-only memory (“ROM”), random access memory (“RAM”), other non-transitory computer-readable media, or a combination thereof. The memory 152 can include instructions 158 (e.g., machine-readable instructions) for the electronic processor 150 to execute. The instructions 158 can include software executable by the electronic processor 150 to enable the electronic processor 150 to, among other things, receive data and/or commands, transmit data, control operation of a connected primary camera 102 and/or auxiliary camera 104, and the like. The software can include, for example, firmware, one or more applications, program data, filters, rules, one or more program modules, and other executable or otherwise machine-readable instructions.

The electronic processor 150 retrieve the instructions 158 from memory 152 and execute, among other things, instructions related to the control processes and methods described herein. The electronic processor 150 is also configured to store data on the memory 152 including audio stream data, video stream data, camera calibration data, camera control parameters, and the like.

Additionally, the electronic processor 150 may store other data on the memory 152 including information identifying participants in a videoconference environment; the locations of participants in the videoconference environment, which may include bounding boxes or other regions identified in the video streams captured by the primary camera(s) 102 and/or auxiliary camera(s) 104; estimated poses of the identified participants (e.g., estimated yaw values for the head pose of each participant in each video stream, estimated pitch values for the head pose of each participant in each video stream, estimated direction of eye gaze of each participant in each video stream); ranking values that rank the pose of each participant in each video stream; and so on.

The network interface 154 provides communications between the videoconferencing system 120 and the remote endpoint(s) 135. As described above, the videoconferencing system 120 can communicate with the remote endpoint(s) 135 via the network 140, or alternatively may interface with each other to provide a direct communication link (e.g., via the network interface 154 of the videoconferencing system 120 and a corresponding network interface of the remote endpoint(s) 135).

In some examples, the network interface 154 may communicate using a wireless communication protocol, such as Wi-Fi®, Bluetooth®, cellular protocols, a proprietary protocol, and so on. For example, the network interface 154 may communicate via Wi-Fi® through a wide area network such as the Internet or a local area network. The communication via the network interface 154 may be encrypted to protect the data exchanged between the videoconferencing system 120 and the remote endpoint(s) 135 from third parties.

The videoconferencing system 120 may include at least one speaker 108. The speakers 108 can be used to play videoconference audio received from the remote endpoint(s) 135 to participants in the local videoconference environment.

The videoconferencing system 120 may also include at least one display 110. The displays 110 can be used to display videoconference video received from the remote endpoint(s) 135 to participants in the local videoconference environment. In some examples, a display 110 can include a flat panel display, such as a liquid crystal display (“LCD”) panel, an LED display panel, and the like. The display 110 can also present additional information to a user. For example, the display 110 can provide a graphical user interface (“GUT”) for controlling operations of the primary camera(s) 102, the auxiliary camera(s) 104, or both. Additionally or alternatively, the GUI can be presented to a user for controlling operations of the videoconferencing system 120 and its interactions with the remote endpoint(s) 135, such as controlling participant interactions, controlling the videoconference audio and video settings, and so on.

During a videoconference, the primary camera(s) 102 and auxiliary camera(s) 104 capture video streams and provide those video streams to the electronic processor 150 for processing. As described above, the videoconferencing system 120 uses the primary camera(s) 102 and auxiliary camera(s) 104 to dynamically switch between different views of the videoconference environment, such that an optimal framing of a participant of interest can be provided for display by the remote endpoint(s) 135.

The primary camera(s) 102 may include static, or fixed, cameras with a wide-angle view. Using the primary camera(s) 102, for example, the videoconferencing system 120 captures video of the room, or at least a wide or zoomed-out view of the room, that may include all the videoconference participants as well as some of the surroundings in the videoconference environment. In some example, the primary camera(s) 102 may be controllable to adjust panning, tilting, and zooming of the camera to control its view and to frame the environment. In some examples, the videoconferencing system 120 may include a single primary camera 102. In other examples, the videoconferencing system 120 may include two or more primary cameras 102. In general, the one or more primary cameras 102 may be referred to as a first camera system of the videoconferencing system 120. In most examples, a primary camera 102 may be a static camera with a wide view angle, as described above. In some other examples, a primary camera 102 may include a PTZ camera.

When more than one primary camera 102 are used, a single one of the primary cameras 102 may be selected to calibrate the auxiliary camera 104, or alternatively, different ones of the primary cameras 102 may be used to calibrate different ones of the auxiliary cameras 104.

For instance, a primary camera 102 having a field-of-view that significantly overlaps with the field-of-view of an auxiliary camera 104 may be used to calibrate that auxiliary camera 104 versus another primary camera 102 whose field-of-view does not significantly overlap with that auxiliary camera 104. In general, the primary cameras 102 that provide the most spatial overlap in the scene with an auxiliary camera 104 can be used to calibrate that auxiliary camera 104 since there is more spatial information shared between those cameras.

The auxiliary camera(s) 104 may be controllable cameras with a wide-angle view or a narrower view angle than the primary camera(s) 102. In some examples, the videoconferencing system 120 may include a single auxiliary camera 104. In other examples, the videoconferencing system 120 may include two or more auxiliary cameras 104. In general, the one or more auxiliary cameras 104 may be referred to as a second camera system of the videoconferencing system 120. As described below, the auxiliary camera(s) 104 may include PTZ cameras, static cameras, or combinations of both.

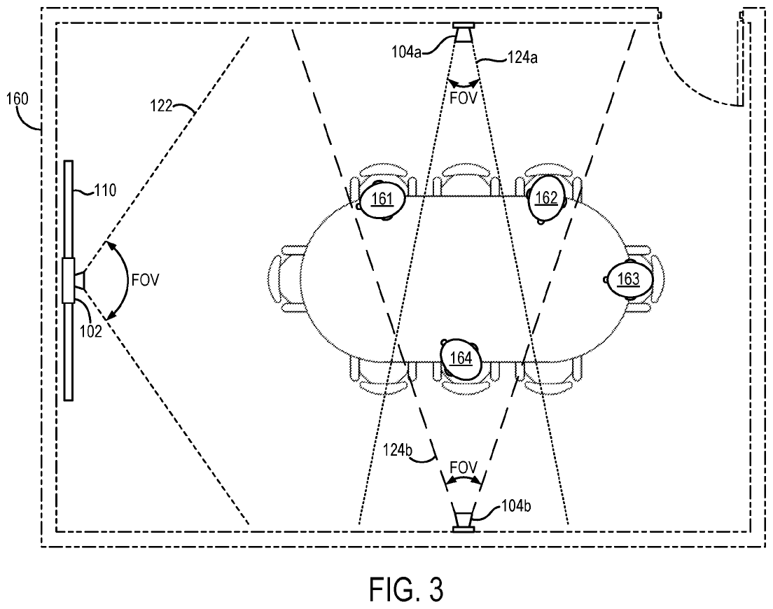

In some examples, the auxiliary camera(s) 104 may be facing in the same direction as the primary camera(s) 102. In some other examples, the auxiliary camera(s) may be facing in different directions than the primary camera(s) 102. For instance, in the example configuration illustrated in FIG. 3, a primary camera 102 is facing a first direction; a first auxiliary camera 104a is facing a second direction that is perpendicular to, or otherwise at an angle with respect to, the first direction; and a second auxiliary camera 104b is facing a third direction that is also perpendicular to, or otherwise at an angle with respect to, the first direction. The second and third directions illustrated in FIG. 3 may be opposed to each other, such that different sides of a conference table can be viewed by the first and auxiliary cameras 104a, 104b. The primary camera(s) 102 and auxiliary camera(s) 104 may have overlapping fields-of-view, or some of the cameras may have fields-of-view that do not overlap with others. As a non-limiting example, a single primary camera 102 may have a field-of-view that overlaps with the field-of-view of two auxiliary cameras 104, yet those two auxiliary cameras 104 may have fields-of-view that do not overlap each other. Similarly, the videoconferencing system 120 may include two primary cameras 102 and multiple auxiliary cameras 104, where one primary camera 102 has a field-of-view that overlaps the field-of-view of only some of the auxiliary cameras 104, whereas the second primary camera 102 has a field-of-view that overlaps the field-of-view of others of the auxiliary cameras

In some examples, the auxiliary camera(s) may be a PTZ camera. The PTZ camera may be a mechanical PTZ camera (“MPTZ”), in which the pan, tilt, and zoom functions of the camera are achieved through mechanically controlling the optics in the camera, or may be an electronic PTZ camera (“EPTZ”), in which the pan, tilt, and zoom functions of the camera are achieved by digitally panning, tilting, and zooming within a larger field-of-view to frame a smaller field-of-view. In some other examples, the auxiliary camera(s) 104 may be a static camera with a wide view angle or a narrow view angle.

The videoconferencing system 120 uses the auxiliary camera(s) 104 to capture video of one or more participants in the videoconference environment, such as the active speaker or another participant of interest, in a tight or zoomed-in view. In some examples, the auxiliary camera(s) 104 may include PTZ cameras. An auxiliary camera 104 may be a mechanical PTZ camera, or in some instances may be an electronic PTZ camera. The auxiliary camera(s) 104 may have a narrow-angle view or a wide-angle view. In some instances, the auxiliary camera(s) 104 may have a narrower view angle than the primary camera 102, or when multiple primary cameras 102 are used may have a narrower view angle than at least one of the primary cameras 102.

Additionally, at least one microphone 106 may capture audio streams and provide those audio streams to the electronic processor 150 for processing. As a non-limiting example, the microphone(s) 106 may be tabletop microphones, microphones integrated with the primary camera(s) 102, microphones integrated with the auxiliary camera(s), or so on. The videoconference system 120 uses the audio streams captured by the microphone(s) 106 for the videoconference audio. In some examples, additional microphones or microphone arrays may also be used to capture audio streams for camera tracking purposes. For instance, additional audio streams can be captured and processed by the electronic processor 150 to determine locations of audio sources during the videoconference, such as the location of a participant who is actively speaking.

The electronic processor 150 sends the captured audio and video streams to the remote endpoint(s) 135. In some examples, the electronic processor 150 encodes the video streams using an encoding standard. For instance, the video stream may be encoded using an encoding standard such as MPEG-1, MPEG-2, MPEG-4, H.261, H.263, H.264, or the like. The electronic processor 150 may also encode the audio streams using a suitable codec. The electronic processor 150 outputs the encoded audio and video streams to the network interface 154, which then communicates the encoded audio and video streams to the remote endpoints(s) 135 over the network 140. Similarly, the network interface 154 receives audio and video streams communicated from the remote endpoint(s) 125 over the network 140. The audio and video streams received from the remote endpoint(s) 125 are communicated from the network interface 154 to the electronic processor 150. The electronic processor 150 sends the received audio stream(s) to speakers 108 to output videoconference audio captured from the remote endpoint(s), and sends the received video stream(s) to a display 110 to output videoconference video captured from the remote endpoint(s) 135.

As described above, it is an advantage of the present disclosure that the electronic processor 150 can process the video steams captured from the primary camera(s) 102 and auxiliary camera(s) 104 to automatically frame a participant of interest (e.g., the current speaker) in a videoconference by selecting a video stream that optimally frames the participant's face. As an example, the electronic processor 150 may process the video stream captured from the primary camera 102 to identify the participant of interest in the primary camera video stream. The location of the participant of interest may be mapped from the primary camera video stream to the auxiliary camera video stream(s). In some examples, a dynamic feature mapping is performed by the electronic processor 150 to map the location of the participant of interest from the primary camera video stream to the auxiliary camera video stream(s).

With the participant of interest identified in each video stream, the electronic processor 150 processes the video streams to estimate or otherwise determine the pose of the participant of interest in each video stream. The pose may be a head pose, a body pose, or the like. The estimated poses in each video stream are then ranked by the electronic processor 150 to determine which video stream optimally frames the participant of interest. Based on these rankings, the electronic processor 150 selects the video stream that best frames the participant of interest and sends the selected video stream to the network interface 154 to be sent for display at the remote endpoint(s) 135.

In some examples, the videoconferencing system 120 outputs a video stream from one of the primary camera(s) 102 or auxiliary camera(s) 104 at any particular time. As described above, during the videoconference the output video stream from the videoconferencing system 120 is automatically switched between the primary camera(s) 102 and auxiliary camera(s) 104 to select the video view that best frames a participant of interest (e.g., the active speaker).

When the selected video stream is captured from the auxiliary camera(s) 104, the videoconferencing system 120 may periodically switch between the selected video stream and the video stream captured by the primary camera(s) 102, such that the remote endpoint(s) 135 may appreciate zoomed-in views of active speakers, or other participants of interest, while still periodically viewing a wide view of the videoconference environment (e.g., to see the other participants).

In some other examples, the videoconferencing system 120 can transmit video streams from both the primary camera(s) 102 and auxiliary cameras 104 simultaneously, while switching between different video streams captured from different auxiliary cameras 104 based on which auxiliary camera 104 best frames the participant of interest as the videoconference progresses. In these instances, the electronic processor 150 can send the video streams to the remote endpoint(s) 135 so that one of the video streams may be composited as a picture-in-picture with the other video stream. For example, the auxiliary camera video stream can be composited with the primary camera video stream by the electronic processor 150, and the composited video stream can be sent to the remote endpoint(s) 135 for display in a picture-in-picture format. Alternatively, the video streams can be sent by the electronic processor 150 to the remote endpoint(s) 135 where the video streams can be composited by an electronic processor of the remote endpoint(s) 135.

As described above, a videoconferencing system may use multiple cameras that can be calibrated to each other based on dynamic feature mapping, or other techniques for relating the coordinate systems of multiple cameras to each other. In some examples, a dynamic feature mapping-based calibration process may be implemented in real-time without the use of external references (e.g., patterns, including checkerboards, dot charts, etc.). Dynamic feature mapping may instead generate calibration data based on real-time scene data (e.g., conference room data) in the video streams captured by the multiple cameras.

With reference to FIG. 3, an example videoconferencing system 120 may include a primary camera 102, a first auxiliary camera 104a, and a second auxiliary camera 104b. The primary camera 102 may be coupled to a display 110, such as by clipping onto or otherwise attaching to an edge or surface of the display 110. Alternatively, the primary camera 102 may be integrated with the display 110.

In the illustrated example, the primary camera 102, first auxiliary camera 104a, and second auxiliary camera 104b capture video streams that each depict a scene in the videoconference environment 160. For instance, the videoconference environment 160 may include a conference room in which multiple participants 161, 162, 163, 164 are seated at a conference table.

In the illustrated example, the field-of-view (“FOV”) 122 of the primary camera 102 may have a wide view angle that facilitates viewing the videoconference environment 160 (e.g., conference room) whereas the FOV 124a of the first auxiliary camera 104a and/or the FOV 124b of the second auxiliary camera 104b may have a narrower view angle that facilitates more optimal framing of the participants 161, 162, 163, 164.

As will be described in more detail below, the primary camera 102 can be used to capture a video stream that depicts the scene including all of the participants 161, 162, 163, 164 in the videoconference environment 160. When participant 161 is the active speaker, the video stream from the primary camera 102 may provide the best framing for that participant 161. When participant 162 is the active speaker, however, then the video stream from the primary camera 102 may not optimally frame that participant 162. For instance, the participant 162 is at the far-end of the videoconference environment 160 relative to the primary camera 102, and so will likely appear small in the video stream. In this instance, the participant 162 may be identified in the video stream captured by the primary camera 102 and the location data associated with the participant 162 may be mapped to the video stream being captured by the second auxiliary camera 104b, which provide a more optimal view of the participant 162. As mentioned above, a calibration between the primary camera 102 and the second auxiliary camera 104b, which may be based on dynamic feature mapping between the two cameras, facilitates this mapping of the participant location data.

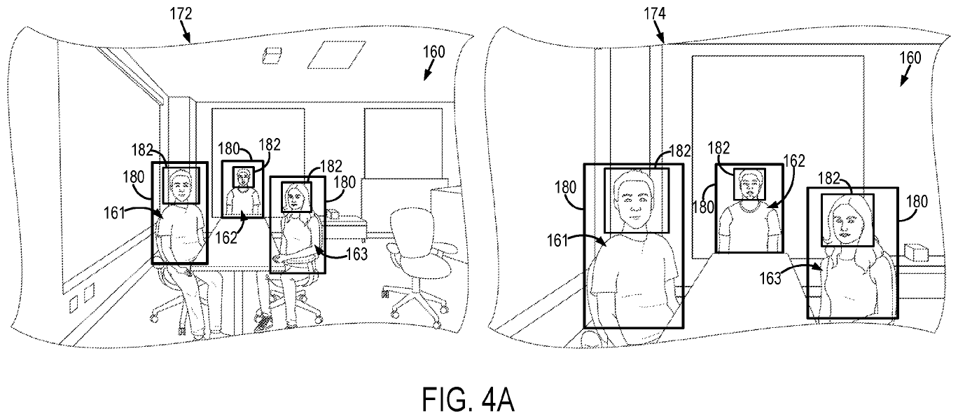

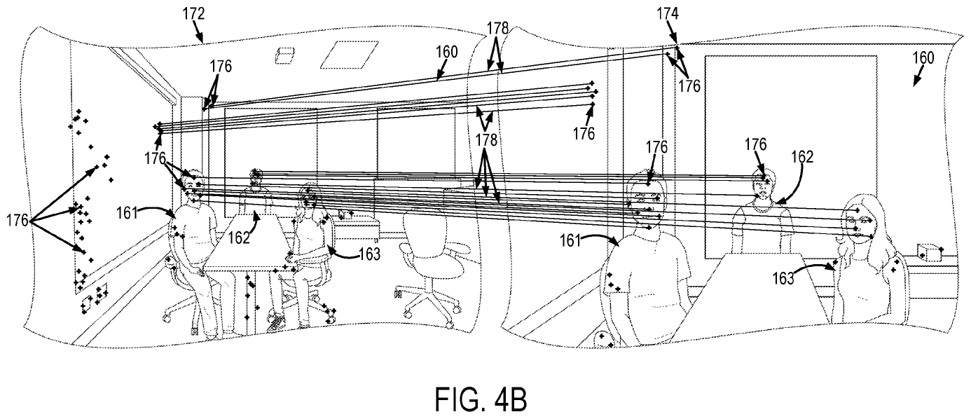

With reference now to FIGS. 4A and 4B, a non-limiting example of such a dynamic feature mapping-based calibration process is described. In the illustrated example, a first video stream is captured using a primary camera that is a static wide-angle view camera and a second video stream is captured using an auxiliary camera that is an MPTZ camera. In this example, both cameras are forward-facing on the videoconference environment 160, which contains three participants 161, 162, 163. The first and second video streams are received by the electronic processor 150 of the videoconferencing system 120 where they are processed to generate calibration data that relates the coordinate system of the primary and auxiliary cameras.

A first image frame 172 is selected, by the electronic processor 150, from the first video stream captured from the primary camera. Likewise, a second image frame 174 is selected, by the electronic processor 150, from the second video steam captured from the auxiliary camera, where the first and second image frames 172, 174 were captured at the same time by the respective cameras. Additionally or alternatively, multiple images may be captured by the auxiliary camera and may be stitched together by the electronic processor 150 to generate a composite image frame (or composite video stream) that matches the wide-angle view of the primary camera.

Features 176 are identified in the first image frame 172 and the second image frame 174 using the electronic processor 150 to perform feature detection and matching on the first and second image frames 172, 174. As a non-limiting example, features 176 may be extracted from the first and second image frames 172, 174 using a scale-invariant feature transform (“SIFT”) operation. The extracted features 176 can then be matched by the electronic processor 150 using a feature matching process. As a non-limiting example, the features 176 extracted from the first image frame 172 can be matched to corresponding features 176 extracted from the second image frame 174 using a k-nearest neighbors (“k-NN”) process. Alternatively, other artificial intelligence or machine learning processes or models may be used to match features extracted from the first and second image frames. Matched features 176 are illustrated in FIG. 4B by the lines 178 connecting the features 176 from the first image frame 172 that are matched to corresponding features 176 in the second image frame 174.

Using these matched features, a transformation matrix is constructed by the electronic processor 150. In a non-limiting example, features that are matched with a threshold level of confidence (e.g., features that are matched with a high level of accuracy) are considered by the electronic processor 150 when generating the transformation matrix. The transformation matrix may be a homography matrix. Additionally or alternatively, the transformation matrix may account for both local homography and global similarities between the first and second image frames. By using both local homography and global similarities when constructing the transformation matrix, the functionality of the auxiliary camera for participant framing can be improved.

Then, using primary camera images, the videoconference participants 162, 164, 166 are detected and their locations determined by processing the first video stream with the electronic processor. Using the detected participants, a facial detection process can be performed by the electronic processor 150 on the first video stream to detect the head position of each participant 161, 162, 163 in the first video stream. The participant locations and head positions can be identified by bounding boxes 180, 182, or may alternatively be identified by other indicators, by identifying the groups of pixels associated with the participant locations and/or head positions, and so on.

The participant location data (e.g., participant locations, head positions) are then mapped from the first video stream to the second video stream by the electronic processor 150 using the constructed transformation matrix.

In some examples, the mapped participant location data can then be used to determine camera parameters for the auxiliary camera that will provide for optimal framing of each participant. As a non-limiting example, for each detected bounding box mapped to the second video stream, the distance from the center of bounding box to the center of the second video stream image frame is calculated. Using this distance, pan and tilt parameters are estimated by the electronic processor 150 for the auxiliary camera. Furthermore, using bounding box size, the zoom factor for the auxiliary camera may be estimated by the electronic processor 150. In the case of availability of depth map it is used to estimate the zoom factor.

$$Z F ∝ \frac{1}{H B B} , or$$

$$ZF ∝ HD$$

where ZF is the zoom factor, HBB is the size of the head bounding box, and HD is the head depth.

As a non-limiting example, equations for both pan and tilt factors can be estimated using a regression model. Example equations for pan and tilt factors are as follows.

$$Pan = ( - x \pm 19.083 ) / 27 \text{.99} \qquad ( ‘ + ’ for right pan and ‘ - ‘ for left pan )$$

$$Tilt = ( y \pm 3.2 ) / 2 4.42 ) \qquad ( ‘ + ’ for up pan and ‘ - ‘ for down pan )$$

where, x and y are distances estimated from center.

The participant of interest and its placement in the second video stream image frame may also be determined by using sound source localization (“SSL”) from audio and speakers, as described above. This location data may be used by the electronic processor 150 to estimate the pan, tilt, and zoom factors for the auxiliary camera, which can then be sent by the electronic processor 150 to the auxiliary camera 104 to move the auxiliary camera 104 to frame the participant's head.

Once the auxiliary camera is moved to frame the participant of interest, the head pose of the participant is estimated by the electronic processor 150 in both the first and second video streams. As a non-limiting example, the head pose (or other body pose) can be estimated in terms of yaw and pitch (e.g., pitch down) relative to the respective camera used to capture the video stream being processed by the electronic processor 150. As another example, the head pose may include the eye gaze direction of the participant (i.e., the direction in which the participant is looking). In these instances, the eye gaze direction may be expressed as coordinates in three-dimensional space. The eye gaze direction can be estimated by the electronic processor 150 in both the first and second video streams. As one non-limiting example, eye gaze direction can be estimated in terms of yaw relative to the respective camera used to capture the video stream being processed by the electronic processor 150.

The head pose data for the first video stream and the second video stream may then be ranked by the electronic processor 150, such as by comparing the individual head pose data sets to reference head pose data, which may include threshold values for different head pose parameters (e.g., a yaw threshold, a pitch down threshold, and eye gaze direction threshold). Head poses with larger yaw values (i.e., where the face orientation is more turned away from the camera, where the eye gaze direction is more turned away from the camera) can receive a lower rank score and similarly head poses with larger pitch values (i.e., where the face orientation is more pitched away from the camera) can receive a lower rank score. For instance, if the estimated yaw values for a head pose are less than 3 degrees and/or the estimated pitch values are less than 3 degrees, a video stream can be more highly ranked than those with larger yaw and/or pitch values. As a non-limiting example, different ranges of yaw or pitch values can be assigned different rank scores, such as yaw or pitch values between 0-5 degrees can receive a rank score of 1, yaw or pitch values between 5-10 degrees can receive a rank score of 2, yaw or pitch values between 10-25 degrees can receive a rank score of 3, and so on. In this example, rank scores are assigned based on 5-degree ranges of yaw and pitch. In other examples, different ranges of yaw and pitch values can be used (e.g., smaller ranges or larger ranges). Additionally or alternatively, rank scores can be assigned on a continuous basis, such as by using the estimated yaw or pitch value as the rank score values. As noted above, the yaw values may be estimated for head, eye gaze direction, or both. Similarly, different threshold values can be established the head yaw and eye gaze direction.

The combined yaw rank score and pitch rank score for a head pose can be used as the overall rank score for the head pose, with higher valued rank scores corresponding to a lower-ranked head pose. Alternatively, the estimated yaw and pitch values, or other pose data values, can be assigned to any arbitrary rank score scale. For example, the first and second video streams can be ranked from 1-5, 1-10, or the like, with 1 being the worst rank and 5 (or 10) being the best rank. The more highly ranked video stream is then sent by the electronic processor 150 to the remote endpoint 135 for viewing by remote participants.

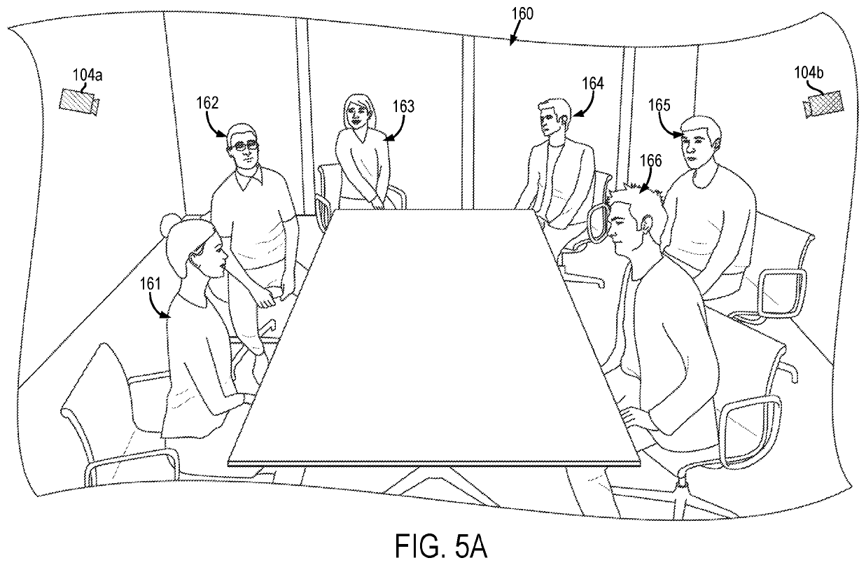

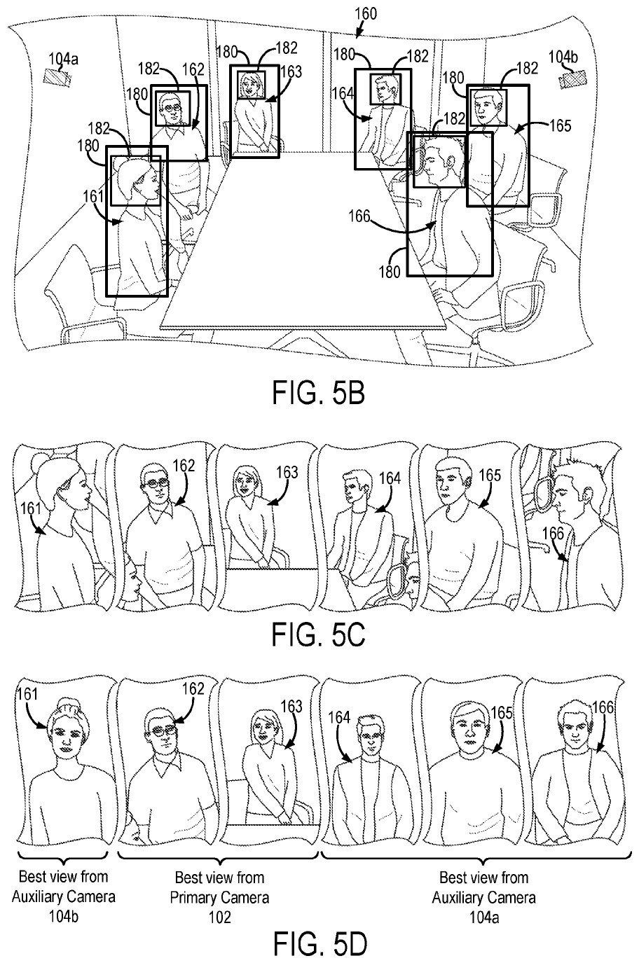

With reference to FIGS. 5A-5D, an example process for ranking the pose of videoconference participants is illustrated. FIG. 5A shows an example video stream image from a primary camera that has a static, wide-angle view of the videoconference environment 160. In the illustrated example, six participants (161, 162, 163, 164, 165, 166) are seated around a conference table. A first auxiliary camera 104a is arranged on one side of the videoconference environment 160 opposite a second auxiliary camera 104b, similar to the arrangement illustrated in FIG. 3.

The locations of the participants are identified in the primary camera video stream, as indicated in FIG. 5B. For example, as described above, the participant location data may include regions that are identified as containing the body of each participant, the head of each participant, or both. The participant location data may include bounded boxes (e.g., body bounding boxes 180, head bounding boxes 182), other indicators, groups of pixels, and so on.

FIG. 5C illustrates the framing of participants using previous techniques that utilized only a single, wide angle-view camera, such as the primary camera of the videoconferencing systems described in the present disclosure. In this illustrated example, the framing of participants 162 and 163 may be good, but the framing of participants 161, 164, 165, and 166 leaves only parts of the faces of the participants oriented towards the camera. This suboptimal participant framing is overcome using the techniques described in the present disclosure. By mapping the participant location data from the primary camera video stream to the video streams captured by the first and second auxiliary cameras 104a, 104b, participant pose data can be estimated for each participant 161, 162, 163, 164, 165, 166 in each video stream, and the pose data can be ranked as discussed above. Based on these rankings, the optimal view for framing participant 161 is determined by the electronic processor 150 to be from the first auxiliary camera 104a, and the optimal views for framing participants 164, 165, and 166 is determined by the electronic processor 150 to be from the second auxiliary camera 104b. Accordingly, as the participant of interest changes during a videoconference, the electronic processor 150 may send the different video streams to the display system (e.g., the display system of the remote endpoint 135) based on which video stream optimally frames the current participant of interest.

Referring now to FIG. 6, a flowchart is illustrated as setting forth the steps of an example method for automatically selecting video streams captured from different cameras of a multiple-camera videoconferencing system based on the video stream that optimally frames a participant of interest. As described above, calibration between the multiple cameras may be performed to facilitate identifying the videoconference participants in the multiple video streams without duplicates.

A first video stream is received by the electronic processor 150 from a first camera, as indicated at step 602. For example, the first video stream can be received by the electronic processor 150 from a primary camera 102. As described above, the primary camera 102 has a wide-angle view of the videoconference environment (e.g., a conference room). Accordingly, the first video stream depicts a scene corresponding to the videoconference environment and any participants within the videoconference environment.

A second video stream is also received by the electronic processor 150 from a second camera, as indicated at step 604. For example, the second video stream can be received by the electronic processor 150 from an auxiliary camera 104. The auxiliary camera 104 has a different view of the videoconference environment (e.g., a conference room). Accordingly, the second video stream depicts the same scene corresponding to the videoconference environment and any participants within the videoconference environment, but from a different perspective than the primary camera. The different perspective may correspond to a different view angle (e.g., a narrower view angle), a different view direction, or a combination of both.

In some examples, the second video stream may include a composite video stream that is generated by the electronic processor 150 by compositing different image data captured by the second camera to match the FOV of the first camera. For instance, image data can be captured by the second camera over a wider view angle by capturing image data at when moving the second camera through different pan and tilt values. These image data can be composited to generate a composite video stream, or image data, that can be processed by the electronic processor 150 when calibrating the first and second cameras, as described below in more detail.

The first video stream is processed by the electronic processor 150 to identify a participant of interest in the first video stream, as indicated at step 606. Additionally or alternatively, other participants can be similarly identified in the first video stream by processing the first video stream with the electronic processor 150. Advantageously, as participants move into the videoconference environment from an out-of-frame location, the locations of the new participants can be identified in real-time and updated.

In some examples, identifying a participant in the first video stream can include processing the first video stream with a facial detection process to determine or otherwise identify a region of the first video stream corresponding to, or otherwise containing, a face of the participant. This process can be repeated for each participant depicted in the first video stream. As one example, the electronic processor 150 can output a bounding box or other indicator for identifying the spatial region in the first video stream corresponding to a particular participant. Alternatively, the region (e.g., group of pixels) of the first video stream identified as corresponding to or otherwise containing the face of the participant can be identified and their locations stored by the electronic processor 150. In some other examples, identifying a participant in the first video stream can include identifying the body of the participant in addition, or as an alternative, to the face of the participant. The location of the body can similarly be identified and output as a bounding box, other indicator, group of pixels, or so on.

Additionally, the electronic processor may also receive audio stream data from a microphone 106 of the videoconferencing system 120 to facilitate locating and identifying participants in the videoconference environment. For example, an audio-based localization can be used to identify different participants in the videoconference environment.

The location of the participant of interest, and/or other identified videoconference participants, is then mapped from the first video stream to the second video stream by the electronic processor 150, as indicated at step 608. Accordingly, the participant of interest, or other participants, may be localized in the second video stream based on the processed first video stream. As a non-limiting example, mapping the participant location data from the first video stream to the second video stream may be facilitated by calibration data corresponding to the camera used to capture the first video stream (e.g., a primary camera) and the camera used to capture the second video stream (e.g., an auxiliary camera).

In some examples, a calibration procedure may be performed by the electronic processor 150 to generate calibration data that are used when mapping the participant location data from the first video stream to the second video stream. The calibration procedure may use dynamic feature mapping to estimate camera parameters of the first and second cameras to match the FOV and position of the second camera with respect to the first camera. For example, the calibration data may include data that relate the coordinate system of the second camera to that of the first camera.

Advantageously, by identifying participants in the first video stream, which may be a wide-angle view of the videoconference environment such that all videoconference participants may be viewed in the first video stream, and then mapping those participant location data to the second camera (or other cameras in the videoconferencing system, such as other auxiliary cameras), participant discrimination can be achieved across multiple cameras to prevent duplication of users in composited video. Because this mapping effectively allows for pixel-for-pixel mapping across these different cameras, participant identification can be made without having to match facial features or other aspects of the participant in different video streams.

As described above, the calibration data may include a transformation matrix that relates the coordinate system of the first camera to the coordinate system of the second camera. The calibration data may be generated by processing the first video stream and the second video stream with the electronic processor 150 to extract or otherwise detect features in both the first video stream and the second video stream. As a non-limiting example, a SIFT operation can be used by the electronic processor 150 to extract features from the first and second video streams. The extracted features from the first video stream may then be matched to extracted features in the second video stream by the electronic processor 150. As a non-limiting example, a KNN process or other machine learning model can be applied to the extracted feature data using the electronic processor 150. Based on the matched features, the electronic processor 150 may construct a transformation matrix, which may account for local homography, global similarities, or both. The constructed transformation matrix may be stored by the electronic processor 150 as the calibration data (e.g., by storing the transformation matrix in the memory 152).

A pose of the participant of interest is estimated from the first video stream by the electronic processor 150, generating first pose data as an output, as indicated at step 610. For instance, the region containing the participant of interest is extracted from the first video stream and the first pose data are estimated from the extracted region. In one example, the region may include a bounding box containing the identified participant of interest. The region may correspond to the participant's head, their body, or both. Accordingly, the pose data may be head pose data (or face orientation data), body pose data, or both. In general, the pose data include estimates of pitch, rotation, and/or tilt relative to the first camera. For example, the pose data may include estimates of yaw values and pitch values relative to the image plane of the first camera.

Additionally or alternatively, the first pose data may include pose data estimated for each participant identified in the first video stream.

Similarly, a pose of the participant of interest is estimated from the second video stream by the electronic processor 150, as indicated at step 612. For instance, the region containing the participant of interest, which for example has been mapped from the first video stream to the second video stream, is extracted from the second video stream and the second pose data are estimated from the extracted region. In one example, the region may include a bounding box containing the identified participant of interest. The region may correspond to the participant's head, their body, or both. Accordingly, the pose data may be head pose data (or face orientation data), body pose data, or both. In general, the pose data include estimates of pitch, rotation, and/or tilt relative to the first camera. For example, the pose data may include estimates of yaw values and pitch values relative to the image plane of the first camera.

As described above, in some implementations, camera parameters are estimated for the second camera based on processing the region containing the participant of interest in the second video stream. For example, pan, tilt, and/or zoom factors can be estimated to control the second camera to frame the participant of interest.

Additionally or alternatively, the second pose data may include pose data estimated for each participant identified in the second video stream. In these instances, camera parameters may also be estimated for framing each identified participant.

The first and second video streams may then be ranked by the electronic processor 150 based on a comparison of the first and second pose data, as indicated at step 614. As described above, rank scores can be assigned to the first pose data and the second pose data by comparing the pose data to reference or threshold values. Based on the estimated pose, a rating is given to the first and second video streams varying from best to worst.

In some examples, the first pose data and the second pose data may be head pose data. As one example, the head pose data may include an estimate of head pose values, such as head pitch, head rotation, and/or head tilt. The first head pose data and the second head pose data can be ranked based on these head pose values, such as by comparing the values to reference or threshold values that indicate optimal orientation of the face with respect to the imaging plane of the camera. Additionally or alternatively, the first head pose data and the second head pose data can be ranked based on the percentage of the participant's face that is oriented towards the respective camera. Accordingly, the head pose data may include an estimate of the percentage of the participant's face that is oriented towards the camera used to capture the video stream from which the head pose data were estimated. The percentage value may be estimated based on the head pose values, or may be estimated using other processes, such as by inputting the head pose data, the corresponding video stream data, or both, to a machine learning model that has been trained on suitable training data to estimate the percentage of a face that is oriented towards a camera (e.g., the percentage of the face that is oriented in the imaging plane of the camera).

The video stream with the highest ranking is then selected by the electronic processor 150 and the selected video stream is sent to a display system, such as the display system of a remote videoconferencing system 125 at a remote endpoint 135, as indicated at step 616. Accordingly, the electronic processor 150 may automatically switch between the video stream from the different cameras while the videoconference progresses, depending on the identified participant of interest and the video stream that optimally frames that participant of interest.

When the selected video stream corresponds to a video stream captured with a PTZ camera (e.g., the second video stream), the camera parameters estimated for framing the participant of interest with that camera can also be selected by the electronic processor 150. In these instances, the selected camera parameters are then used by the electronic processor 150 to control the respective camera to automatically frame the participant of interest when switching to the video stream that optimally frames the participant of interest. Accordingly, the selected video stream will include a more optimal framing of the participant of interest without a user having to manually readjust the pan, tilt, and zoom of the PTZ camera.

In some implementations, the electronic processor 150 may not automatically switch between video streams, but may instead control the timing of transitioning between video streams, since frequency camera switching can be distracting to the videoconference participants. For example, where the participant of interest is a frequent speaker in the videoconference, the electronic processor 150 can select the video stream that best frames the participant of interest when the begin speaking, but can avoid or delay switching to another speaker who may only be responding with short answers or comments.

Referring now to FIG. 7, a non-limiting example method for automatically switching between video streams captured by a primary camera and an auxiliary camera to optimally frame a videoconference participant of interest is shown. The method generally includes an automatic run-time calibration process to relate the coordinate systems of the primary and auxiliary camera to each other, a participant identification process to identify videoconference participants in the video streams and image frames of the video streams, and a production rules process to automatically frame a participant of interest and to automatically switch to the video stream that provides the optimal framing of the participant of interest.

Video streams are captured by the primary camera at step 702 and by the auxiliary camera at step 704. In some examples, the video streams are captured concurrently such that they depict the same scene of the videoconference environment. An automatic run-time calibration process is then executed by an electronic processor at step 706. The automatic run-time calibration process may be executed once, or may be repeated (e.g., at certain intervals) during a videoconference. The automatic run-time calibration process includes extracting features from the primary camera video stream, or from a selected image frame of the primary camera video stream, as indicated at step 708. As described above, a SIFT operation or other suitable feature extraction process may be used to extract the features. Image frames from the auxiliary video stream are stitched together to create a composite image frame with a FOV that is matched with that of the primary camera, and features are extracted from this composite image frame, as indicated at step 710. As described above, a SIFT operation or other suitable feature extraction process may be used to extract the features from the composite image frame. The extracted features are then matched at step 712. For example, a KNN process can be used to match the features. Alternatively, an other suitable feature matching process may be implemented, including other feature matching processes that implement artificial intelligence and/or machine learning models. Using the matched features, a transformation matrix is generated at step 714. The transformation matrix may be a homography matrix. In some examples, the transformation matrix may account for both local homography and global similarities between the matched features.

Face detection is then performed on the primary camera video stream, or image frame(s) therefrom, as indicated at step 716. If a face is not detected, as determined at decision block 718, then additional video stream data are acquired from the primary camera and the preceding steps are repeated. Additionally or alternatively, a different image frame from the primary camera video stream may be selected and processed using the preceding steps. When at least one face of a participant is detected, a face bounding box is generated for each detected face and the method proceeds by converting each face bounding box to the auxiliary camera video stream (or images frame(s) therefrom) as indicated at step 720. For example, as described above, the face bounding boxes can be converted from the primary camera video stream to the auxiliary camera video stream by applying the transformation matrix to the face bounding boxes.

A participant of interest is then identified at step 722. If no participant of interest is identified, then additional auxiliary camera video stream data (or image frames therefrom) may be acquired and processed using the preceding steps. Otherwise, the method proceeds by estimating camera parameters (e.g., pan/tilt/zoom factors) for the auxiliary camera that will frame the participant of interest in the auxiliary camera video stream, as indicated at step 724. As described above, these camera parameters may be estimated based on the face bounding box of the participant of interest, as converted from the primary camera video stream to the auxiliary camera video stream. The camera parameters can be stored and otherwise sent to the auxiliary camera to control the framing of the auxiliary camera.

The head pose of the participant of interest and other participants in the videoconference are then estimated at step 726. As described above, the head pose may be estimated by calculating the yaw of the head, the pitch of the head, or both. Additionally or alternatively, the head pose may be estimated by calculating a percentage of the face that is oriented to the imaging plane of the respective camera. The video stream that best frames the participant of interest based on their head pose is then selected and displayed (e.g., by sending the selected video stream to a remote endpoint), as indicated at step 728. If the participant does not have the best head pose in the auxiliary camera video stream, the primary camera video stream may be selected and displayed as indicated at step 730.

The present disclosure has described one or more examples, and it should be appreciated that many equivalents, alternatives, variations, and modifications, aside from those expressly stated, are possible and within the scope of the disclosure.

1. A method, comprising:
receiving, by a processor, a first video stream of a scene from a first camera;
receiving, by the processor, a second video stream of the scene from a second camera;
identifying, using the processor, a participant of interest in the first video stream;
identifying, using the processor, the participant of interest in the second video stream by mapping the identified participant of interest from the first video stream to the second video stream;
determining, using the processor and from the first video stream, a first pose of the participant of interest relative to the first camera;
determining, using the processor and from the second video stream, a second pose of the participant of interest relative to the second camera;
ranking, using the processor, the first video stream and the second video stream based on comparing the first pose and the second pose; and
automatically switching between sending, by the processor, one of the first video stream or the second video stream to a display system based on the respective one of the first video stream or the second video stream having a higher ranking.

2. The method of claim 1, wherein identifying the participant of interest comprises determining a group of pixels in the first video stream that are associated with the participant of interest.

3. The method of claim 2, wherein mapping the identified participant of interest from the first video stream to the second video stream comprised mapping the group of pixels in the first video stream to a group of pixels in the second video stream.

4. The method of claim 1, wherein mapping the identified participant of interest from the first video stream to the second video stream comprises:
receiving calibration data with the electronic processor, wherein the calibration data relate a coordinate system of the first camera to a coordinate system of the second camera; and
mapping the identified participant of interest from the first video stream to the second video stream using the calibration data.

5. The method of claim 4, wherein receiving the calibration data with the electronic processor comprises performing dynamic feature mapping between the first video stream and the second video stream using the electronic processor, generating the calibration data as an output.

6. The method of claim 5, wherein the electronic processor performs the dynamic feature mapping by:
extracting features from the first video stream;
extracting features from the second video stream;
matching features from the first video stream with features from the second video stream; and
generating a transformation matrix that maps the features from the first video stream to matched features in the second video stream.

7. The method of claim 1, wherein ranking the first video stream and the second video stream comprises comparing the first pose and the second pose to reference pose data that associate ranges of pose values to rank score values.

8. The method of claim 7, wherein determining the first pose comprises determining first pose data comprising at least one of a first yaw value or a first pitch value, determining the second pose comprises determining second pose data comprising at least one of a second yaw value or a second pitch value, and comparing the first pose and the second pose comprises comparing the first pose data and the second pose data to the ranges of pose values.

9. The method of claim 1, wherein the first camera comprises a static camera and the second camera comprises a pan-tilt-zoom camera.

10. A non-transitory computer-readable storage medium having stored thereon instructions that when executed by a processor cause the processor to:
receive a first video stream of a scene from a first camera;
receive a second video stream of the scene from a second camera;
identify a participant of interest in the scene based on the first video stream;
determine from the first video stream, a first face orientation of the participant of interest relative to the first camera;
determine from the second video stream, a second face orientation of the participant of interest relative to the second camera;
rank the first face orientation and the second face orientation based on a percentage of the face of the participant of interest depicted in each of the first video stream and the second video stream; and
send one of the first video stream or the second video stream to a display system based on the rank of the first face orientation and the second face orientation.

11. The non-transitory computer-readable storage medium of claim 9, wherein the participant of interest is identified by determining a region in the first video stream containing the participant of interest.

12. The non-transitory computer-readable storage medium of claim 11, wherein the region containing the participant of interest is mapped from the first video stream to the second video stream using calibration data that relate a coordinate system of the first camera to a coordinate system of the second camera.

13. The non-transitory computer-readable storage medium of claim 12, wherein the calibration data comprise a transformation matrix that is generated by:
extracting features from the first video stream;
extracting features from the second video stream;
matching features from the first video stream with features from the second video stream; and
generating the transformation matrix based on the features from the first video stream matched to the features in the second video stream.

14. A system, comprising:
a first camera;
a second camera system comprising at least one camera;
an electronic processor to:
receive a first video stream from the first camera;
receive at least one second video stream, each second video stream being received from one of the at least one cameras in the second camera system;
receive calibration data relating a coordinate system of the first camera to a coordinate system of each camera in the second camera system;
identify pixels in the first video stream corresponding to a participant;
map the pixels in the first video stream to pixels in each second video stream using the calibration data;
determine a first head pose of the participant in the first video stream;
determine a second head pose of the participant in each second video stream;
generate ranking data by ranking the first head pose based on an orientation relative to the first camera and each second head pose based on an orientation relative to each respective camera in the second camera system;
select as a selected video stream one of the first video stream or one of the at least one second video streams having a higher ranking score in the ranking data; and
send the selected video stream to a remote endpoint.

15. The system of claim 14, wherein the first camera comprises a static camera and the second camera system comprises a single pan-tilt-zoom camera.

16. The system of claim 14, wherein the second camera system comprises at least two pan-tilt-zoom cameras.

17. The system of claim 14, wherein the second camera system comprises at least two static cameras.

18. The system of claim 14, wherein the first camera comprises a first camera system including at least two static cameras.

19. The system of claim 18, wherein the processor receives the first video stream from one of the at least two static cameras in the first camera system.
